(19) United States
(12) Patent Application Publication
(10) Pub. No.: US 2020/0146274 A1
(43) Pub. Date: May 14, 2020

(54) RODENT TRAP BAIT

(71) Applicant: Daniel ALGER, Auburn, CA (US)

(72) Inventor: Daniel ALGER, Auburn, CA (US)

(21) Appl. No.: 16/185,343

(22) Filed: Nov. 9, 2018

(51) Int. Cl. A01M 23/24; B65D 75/36

(52) U.S. Cl. CPC A01M 23/245; B65D 75/36

(57) ABSTRACT

Rodent trap bait for spring-activated rodent traps and packaging therefor is disclosed. An example embodiment includes: a twisted wire core; fiber filaments surrounding and captured by the twisted wire core; and a liquid rodent attractant absorbed into the fiber filaments, the fiber filaments being fabricated from a natural or synthetic material to retain the liquid rodent attractant, the fiber filaments being interspersed with colored, fluorescent, or attractive filaments configured to conform to visual and mental triggers associated with small rodents.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2017-2018, Daniel Alger; All Rights Reserved.

### TECHNICAL FIELD

The disclosed subject matter relates to the field of animal traps, rodent traps, and particularly although not exclusively, to rodent trap bait and packaging therefor.

### BACKGROUND

Rodent traps, such as spring-activated mouse or rat traps are well known. These traps typically include a base, a spring-loaded hammer bar, a catch, and a holding bar. The spring-loaded hammer bar is forced against the spring and held in place by the holding bar and the catch. Any slight movement of the catch releases the holding bar, which releases the hammer bar to forcefully trap an animal between the hammer bar and the base. Typically, the catch is baited with some type of food to attract the rodent. The rodent feeding on the bait is supposed to release the catch and activate the trap to catch the rodent. However, conventional bait for these spring-activated traps is unsatisfactory, unsanitary, and sometimes poisonous. Often, cheese or peanut butter is used to bait the trap. However, cheese or peanut butter can be taken by the rodent without springing the trap. Additionally, cheese, peanut butter, or other food-based attractants can dry or spoil over time, can produce undesirable odors, can produce messy and unsanitary conditions, can become poisonous, and can attract house pets, kids, ants, or other bugs. Peanut butter is messy and difficult to apply to the catch. Other food items have been tried as bait for spring-activated traps. However, these food items also tend to spoil, smell, produce messy and unsanitary conditions, become poisonous, and attract house pets, kids, ants, or other bugs. Additionally, these food items are frequently eaten by the intended rodent without setting off the trap.

### SUMMARY

Rodent trap bait for spring-activated rodent traps and packaging therefor is disclosed. The rodent trap bait of various example embodiments comprises a twisted wire core capturing fiber filaments surrounding the core. The fiber filaments can be fabricated from an absorbent natural or synthetic material, which can be soaked in and retain a liquid rodent attractant, such as sunflower seed oil. The fiber filaments can also be interspersed with colored, fluorescent, shiny, or attractive filaments configured to conform to the well-known visual and mental triggers associated with small rodents, specifically mice and rats. As well-known, the vision of rodents is blurry and in gray scale; sharp shiny objects stand out to rodents and are easier for them to see, which draws their curiosity. The twisted wire core with the fiber filaments saturated with a liquid rodent attractant (denoted herein as the rodent trap bait) can be conveniently attached and twisted on to a portion of the catch of a spring-activated rodent trap. Because the rodent trap bait can be securely attached to the trap catch, it is unlikely that an animal can separate the rodent trap bait from the trap without springing the trap. Additionally, because the rodent trap bait of the disclosed embodiments does not use a food-based bait, the rodent trap bait disclosed herein does not spoil, smell, produce messy and unsanitary conditions, is not poisonous, and does not attract house pets, kids, ants, or other bugs. In a described example embodiment, the rodent trap bait can be packaged in a blister-sealed package configured with cutouts or notches to facilitate easy opening and deployment of the rodent trap bait on a trap. As such, the rodent trap bait of the disclosed embodiments can be used without mess or cleanup.

### BRIEF DESCRIPTION OF THE DRAWINGS

Embodiments are illustrated by way of example and not limitation in the figures of the accompanying drawings, in which:

FIGS. 1 and 2 illustrate the rodent trap bait of an example embodiment as attached to the catch of a spring-activated rodent trap;

FIGS. 3 and 4 illustrate the twisted wire core and the fiber filaments of the rodent trap bait of an example embodiment;

FIGS. 5 through 7 illustrate a blister-sealed package of an example embodiment for containing the rodent trap bait; and

FIG. 8 illustrates the process for opening the blister-sealed package of an example embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

According to various example embodiments of the disclosed subject matter as described herein, there is disclosed, illustrated, and claimed an improved form of bait for spring-activated rodent traps and packaging therefor. The rodent trap bait of various example embodiments comprises a twisted wire core capturing fiber filaments surrounding the core. The fiber filaments can be fabricated from an absorbent natural or synthetic material, which can be soaked in and retain a liquid rodent attractant, such as sunflower seed oil. The fiber filaments can also be interspersed with colored, fluorescent, shiny, or attractive filaments configured to conform to the well-known visual and mental triggers associated with small rodents, specifically mice and rats. As well-known, the vision of rodents is blurry and in gray scale; sharp shiny objects stand out to rodents and are easier for them to see, which draws their curiosity. The twisted wire core with the fiber filaments saturated with a liquid rodent attractant (denoted herein as the rodent trap bait) can be conveniently attached and twisted on to a portion of the catch of a spring-activated rodent trap. Because the rodent trap bait can be securely attached to the trap catch, it is unlikely that an animal can separate the rodent trap bait from the trap without springing the trap. Additionally, because the rodent trap bait of the disclosed embodiments does not use a food-based bait, the rodent trap bait disclosed herein does not spoil, smell, produce messy and unsanitary conditions, is not poisonous, and does not attract house pets, kids, ants, or other bugs. In a described example embodiment, the rodent trap bait can be packaged in a blister-sealed package configured with cutouts or notches to facilitate easy opening and deployment of the rodent trap bait on a trap. As such, the rodent trap bait of the disclosed embodiments can be used without mess or cleanup. Additional details of the various example embodiments are provided below.

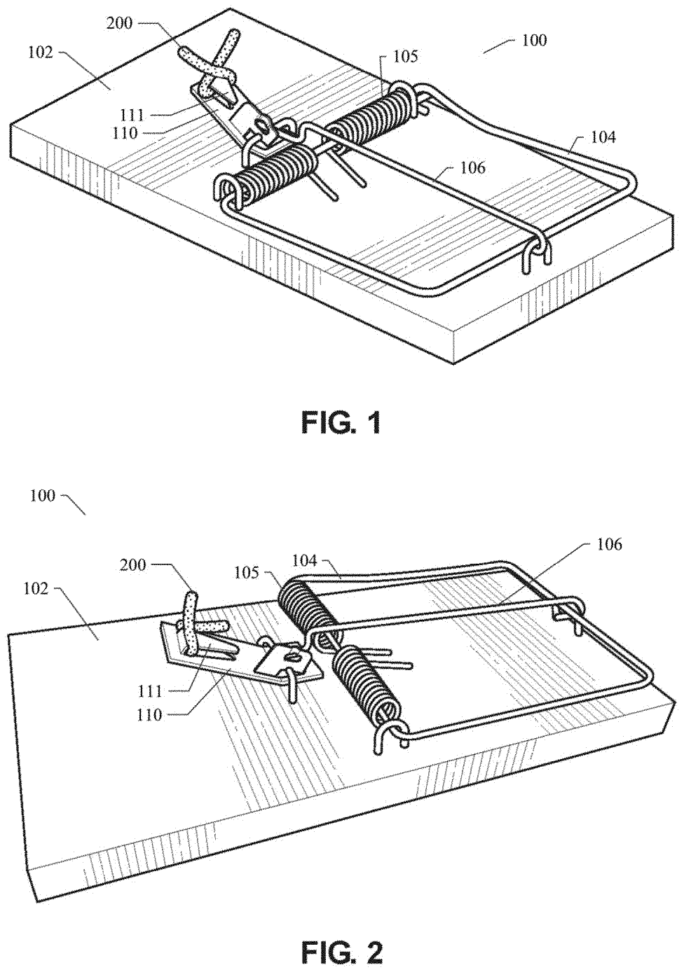

FIGS. 1 and 2 illustrate the rodent trap bait 200 of an example embodiment as attached to the catch 110 of a spring-activated rodent trap 100. As shown in FIGS. 1 and 2, a conventional spring-activated mouse or rat trap 100 can comprise a base 102, a spring-loaded hammer bar 104, a catch 110, and a holding bar 106. The spring-loaded hammer bar 104 is forced against the spring 105 and held in place by the holding bar 106 and the catch 110. Any slight movement of the catch 110 releases the holding bar 106, which releases the hammer bar 104 to forcefully trap an animal between the hammer bar 104 and the base 102. The catch 110 can include a V-shaped tab 111 under which bait can be attached. In the example embodiments described herein, the catch 110 is baited with an improved form of rodent trap bait 200 to attract an animal and cause the rodent to release the catch 110 and activate the trap to catch the rodent. As shown in FIGS. 1 and 2 and described in more detail below, the rodent trap bait 200 can be formed from a wire core, which allows the rodent trap bait 200 to be twisted around the V-shaped tab 111 of the catch 110. As a result, the rodent trap bait 200 can be securely attached to the trap 100 thereby eliminating problems with rodents removing the bait without activating the trap.

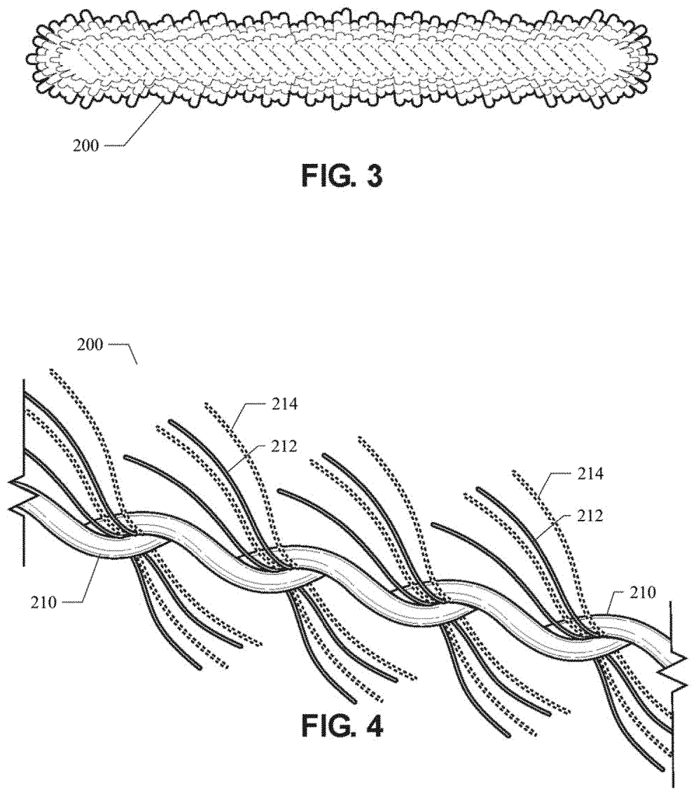

FIGS. 3 and 4 illustrate the twisted wire core and the fiber filaments of the rodent trap bait 200 of an example embodiment. In an example embodiment, the rodent trap bait 200 can comprise a twisted wire core 210 capturing fiber filaments 212/214 surrounding the core 210. The twisted wire core 210 can be fabricated from steel, metal, or bendable wires twisted together to form a twisted or intertwined strand. In an alternative embodiment, a strand of rubber or plastic can also be twisted together with the metal wires for better flexibility and retention of the fiber filaments 212/214. The fiber filaments 212/214 can be fabricated from an absorbent cloth, cotton, polyester, nylon, plastic, rubber, or other natural or synthetic material, which can be soaked in and retain a liquid rodent attractant, such as sunflower seed oil, peanut oil, or other liquid or viscous rodent attractant material. The liquid or viscous attractant material is selected to be non-toxic, non-odoriferous, and safe for pets and kids. The fiber filaments 212/214 can hold the saturation of the attractant oil for long periods of time (e.g., up to a year). The fiber filaments 212/214 can also be interspersed with colored, fluorescent, shiny, or attractive filaments 214 configured to conform to the well-known visual and mental triggers associated with small rodents, specifically mice and rats. As well-known, the vision of rodents is blurry and in gray scale; sharp shiny objects stand out to rodents and are easier for them to see, which draws their curiosity. In an example embodiment, the fiber filaments 212/214 can be of varying colors including fluorescent and neon, green, white, silver, black, and blue. The fiber filaments 212/214 can be of varying lengths, thickness, texture, stiffness, strength, absorption characteristics, materials, and/or the like. The fiber filaments 212/214 are configured to stand stiff and straight, to appear jagged and hold shape without sagging, and to stand out as an attractant to small rodents. The twisted wire core 210 with the fiber filaments 212/214 (denoted herein as the rodent trap bait 200) can be cut into segments of a length appropriate for the particular rodent trap being baited. In an example embodiment, the typical dimensions of the rodent trap bait 200 can be at least 0.25″ in diameter and at least 2.25″ in length. However, it will be understood by those of ordinary skill in the art in view of the disclosure herein that alternative dimensions can also be equivalently used. The rodent trap bait 200, saturated with a liquid rodent attractant, can be conveniently attached and twisted on to a portion of the catch 110 of a spring-activated rodent trap 100 as described above.

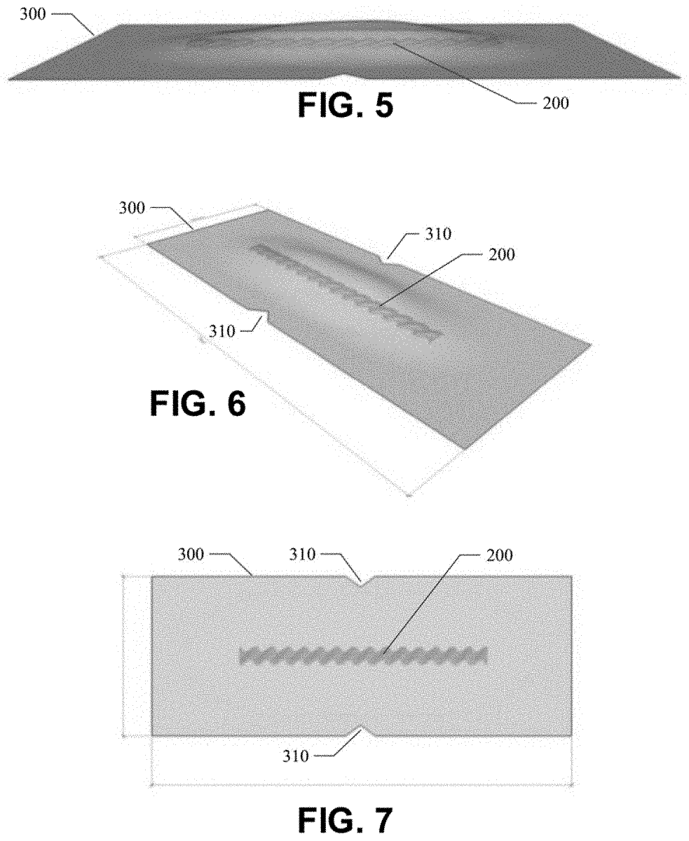

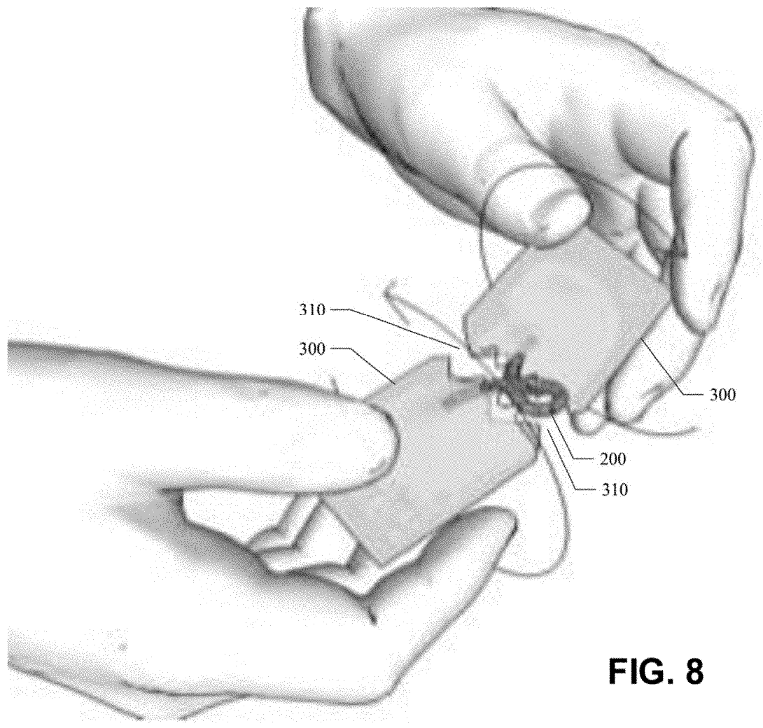

FIGS. 5 through 7 illustrate a blister-sealed package 300 of an example embodiment for containing the rodent trap bait 200. The packaging 300 is perforated with notches in a way that allows the user to remove the rodent trap bait 200 from the packaging 300 and attach the rodent trap bait 200 to a trap 100 without touching the rodent trap bait 200 itself. In an example embodiment, the blister-sealed package 300 can be fabricated from High Density Polyethylene (HDPE), Low Density Polyethylene (LDPE), Linear Low Density Polyethylene (LLDPE), or similar material. As shown in FIGS. 5 through 7, the packaging 300 is configured to capture the rodent trap bait 200 within a bubble or blister in the middle of the package 300 while the edges of the package 300 are heat sealed to contain the rodent trap bait 200 within. In an example embodiment, the package 300 includes two perforated notches 310 cut on the long sides of the package 300 to enable a user to conveniently tear open the package 300 for access to the rodent trap bait 200 therein. This process is illustrated in FIG. 8.

Referring now to FIG. 8, the process for opening the blister-sealed package 300 of an example embodiment is illustrated. As shown, a user can grasp each end of the package 300 and twist the package 300 in opposite directions at the two perforated notches 310. The brittle nature of the packaging 300 facilitates the tearing and opening process. As a result, the package 300 tears open at the two perforated notches 310 to expose the rodent trap bait 200 therein. The user can use the two separated halves of the package 300 to handle the rodent trap bait 200 without touching the rodent trap bait 200. The user can use the package 300 portions to twist the rodent trap bait 200 onto the catch 110 of the trap 100. In this manner, the user is not exposed to the oily attractant absorbed into the rodent trap bait 200. Once the rodent trap bait 200 is attached to the catch 110 of the trap 100, the package 300 portions can be thrown away. Thus, an improved form of bait for spring-activated rodent traps and packaging therefor is disclosed.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, rodent trap bait for spring-activated rodent traps and packaging therefor is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. Rodent trap bait comprising:
a twisted wire core;
fiber filaments surrounding and captured by the twisted wire core; and
a liquid rodent attractant absorbed into the fiber filaments, the fiber filaments being fabricated from a natural or synthetic material to retain the liquid rodent attractant, the fiber filaments being interspersed with colored, fluorescent, or attractive filaments configured to conform to visual and mental triggers associated with small rodents.

2. The rodent trap bait of claim 1 wherein the twisted wire core is fabricated from a material of a type from the group consisting of: steel, metal, and bendable wire material.

3. The rodent trap bait of claim 1 wherein the twisted wire core includes rubber or plastic strands.

4. The rodent trap bait of claim 1 wherein the fiber filaments are fabricated from a material of a type from the group consisting of: an absorbent cloth, cotton, polyester, nylon, plastic, and rubber.

5. The rodent trap bait of claim 1 wherein the liquid rodent attractant is a material of a type from the group consisting of: sunflower seed oil, peanut oil, and a liquid or viscous rodent attractant material.

6. The rodent trap bait of claim 1 wherein the colored, fluorescent, or attractive filaments include colors from the group consisting of: neon, green, white, silver, black, and blue.

7. The rodent trap bait of claim 1 wherein the fiber filaments are of varying lengths, thickness, texture, stiffness, strength, absorption characteristics, and materials.

8. The rodent trap bait of claim 1 wherein the twisted wire core is at least 0.25″ in diameter and at least 2.25″ in length.

9. The rodent trap bait of claim 1 further including a blister-sealed package to contain the rodent trap bait, the blister-sealed package including a blister in a center portion of the package to contain the rodent trap bait, the edges of the blister-sealed package being heat sealed.

10. The rodent trap bait of claim 9 wherein the blister-sealed package includes perforated notches on sides of the blister-sealed package to facilitate opening of the blister-sealed package.

11. The rodent trap bait of claim 9 wherein the blister-sealed package being fabricated from a material of a type from the group consisting of: High Density Polyethylene (HDPE), Low Density Polyethylene (LDPE), Linear Low Density Polyethylene (LLDPE), and a brittle material.
